(19) United States
(12) Patent Application Publication
(10) Pub. No.: US 2024/0336412 A1
(43) Pub. Date: Oct. 10, 2024

(54) Non-Slip Shaving Cream Holder Device

(71) Applicants: Amy Lara, Moses Lake, WA (US); Kade Brodd, Moses Lake, WA (US)

(72) Inventors: Amy Lara, Moses Lake, WA (US); Kade Brodd, Moses Lake, WA (US)

(21) Appl. No.: 18/355,431

(22) Filed: Jul. 20, 2023

Related U.S. Application Data
(60) Provisional application No. 63/494,066, filed on Apr. 4, 2023.

(51) Int. Cl. B65D 59/06; B65D 25/22; F16B 47/00

(52) U.S. Cl. CPC B65D 59/06; B65D 23/001; B65D 25/22; F16B 47/00; B65D 2203/00

(57) ABSTRACT

A non-slip shaving cream holder device is disclosed. The device is a holder that keeps a shaving cream can in place to prevent rust on surfaces, such as a sink. The non-slip shaving cream holder device comprises a body component that is configured in a cylindrical shape to be secured to the bottom of a shaving cream container. The body component would be manufactured of silicone or other flexible material. The body component can also comprise a suction cup component that allows the device to be mounted on a wall surface. Thus, the holder device can be constantly kept in a readily accessible position. The device is also available in multiple sizes to accommodate all types of shaving cream containers.

### CROSS-REFERENCE TO RELATED APPLICATION

The present application claims priority to, and the benefit of, U.S. Provisional Application No. 63/494,066, which was filed on Apr. 4, 2023, and is incorporated herein by reference in its entirety.

### FIELD OF THE INVENTION

The present invention relates generally to the field of non-slip shaving cream holder devices. More specifically, the present invention relates to a cylindrical silicone holder designed to accommodate shaving cream containers. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in non-slip shaving cream holder devices. Generally, shaving cream containers are commonly constructed using metal materials. These containers are commonly stored on a sink area in the bathroom. Over time, the container can leave behind rust stains that need to be constantly cleaned. Further, the containers can slide all over and be at risk for drops and damage.

Unlike most other spray containers, a can of shaving cream is frequently placed on wet surfaces, causing corrosion. For many users, a can of shaving cream may remain in use for several months. The extended exposure to moisture frequently causes unsightly corrosion on the can, which is transferred to other surfaces.

Accordingly, there is a demand for an improved shaving cream holder device that fits over the bottom of a shaving cream can, to protect it from moisture. More particularly, there is a demand for a shaving cream holder device that prevents a shaving cream container from slipping on a bathroom surface and being damaged.

Therefore, there exists a long-felt need in the art for a non-slip shaving cream holder device that provides users with a cylindrical silicone holder designed to accommodate shaving cream containers. There is also a long-felt need in the art for a non-slip shaving cream holder device that allows users to place the holder on a sink surface to keep shaving cream in an easily accessible position. Further, there is a long-felt need in the art for a non-slip shaving cream holder device that prevents rust stains from forming on a sink or other storage area due to the metal shaving cream containers. Moreover, there is a long-felt need in the art for a device that offers a simple and convenient tool for storing shaving cream containers. Further, there is a long-felt need in the art for a non-slip shaving cream holder device that allows users to mount the holder on a wall surface to keep shaving cream in an easily accessible position. Finally, there is a long-felt need in the art for a non-slip shaving cream holder device that is available in multiple sizes to accommodate all types of shaving cream containers.

The subject matter disclosed and claimed herein, in one embodiment thereof, comprises a non-slip shaving cream holder device. The device is a holder that keeps a shaving cream can in place to prevent rust on surfaces, such as a sink. The non-slip shaving cream holder device comprises a body component that is configured in a cylindrical shape to be secured to the bottom of a shaving cream container. The body component would be manufactured of silicone or other flexible material. The body component can also comprise a suction cup component that allows the device to be mounted on a wall surface. Thus, the holder device can be constantly kept in a readily accessible position. The device is also available in multiple sizes to accommodate all types of shaving cream containers.

In this manner, the non-slip shaving cream holder device of the present invention accomplishes all of the foregoing objectives and provides users with a holder for a shaving cream container. The device secures to the bottom of a shaving cream container and keeps the container in place on a sink or other surface. The device can be manufactured of a silicone material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a non-slip shaving cream holder device. The device is a holder that keeps a shaving cream can in place to prevent rust on surfaces, such as a sink. The non-slip shaving cream holder device comprises a body component that is configured in a cylindrical shape to be secured to the bottom of a shaving cream container. Thus, the holder device can be constantly kept in a readily accessible position.

Generally, the lower surface of the rim of a conventional shaving cream container forms the surface on which the container is normally supported in an upright position on a bath or kitchen counter, and it is this surface as well as the lower portions of the container itself that is desired to be protected, since under normal circumstances, it is these areas that are most likely to exhibit rust and leave rust spots or rings brought about either by the direct contact of the rim on the bath or kitchen counters or by condensation picking up such rust or other contamination, as the condensation rolls down the side of the can. Accordingly, the invention is directed to a flexible sleeve, which is fitted over the bottom of a conventional shaving cream container to protect it from moisture and from falling into the sink or bathtub/shower and becoming damaged.

In one embodiment, the non-slip shaving cream holder device comprises a body component. Typically, the body component is configured in a cylindrical shape but can be any suitable size and shape as is known in the art, depending on the size and shape of the bottom of a shaving cream container. Further, the body component would comprise a bottom closed end, side walls configured as a sleeve, and a top open end that allows access to an interior cavity.

In one embodiment, the side walls (i.e., sleeve) would be one-quarter inch to one-half inch tall and once secured to the bottom of the container, would cover approximately one-fourth of the container. In another embodiment, the side walls would be 1-3 inches tall and once secured to the bottom of the container, would cover approximately one-third of the container. In yet another embodiment, the side walls would be 3-6 inches tall and once secured to the bottom of the container, would cover approximately two-thirds of the container. Accordingly, the side walls (i.e., sleeve) can be any suitable length as is known in the art, depending on the needs and/or wants of a user and the size of the shaving cream container.

In addition, the height of the side wall is such that the device can be adequately mounted on the lower portion of the shaving cream container, yet still have sufficient material remaining to extend across the lower rim of the container and at least extend partially upwards toward the top of the container.

In one embodiment, the open top end of the body component comprises a diameter of at least slightly less and possibly significantly less dependent on its ability to stretch, than that of the diameter of the lower portion (i.e., bottom) of the shaving cream container for which it is adapted to be received thereon.

Generally, the device would be provided in a variety of sizes to fit the containers of all the most popular brands of shaving cream. Further, the device can be provided in a variety of sizes to fit travel-size shaving cream containers or other uniquely sized shaving cream containers. Generally, the device is available in multiple sizes to accommodate all types of shaving cream containers. The non-slip shaving cream holder device is intended to be provided as an attachment by the manufacturer of the shaving cream container or purchased separately as an accessory. Further, the non-slip shaving cream holder device may be used with any suitable cylindrical container that fits into it, such as aerosol cans, etc.

In one embodiment, the body component comprises a suction cup component that allows the device to be mounted on a wall surface. Specifically, the suction cup component is secured to the side wall in any suitable position. Generally, the suction cup component is glued to the side wall but can be secured via any suitable securing means as is known in the art. Once in place, the suction cup component can be utilized to mount the device to a wall surface. Specifically, the device can be mounted via the suction cup component, to a shower wall, a bathtub wall, a bathroom wall, or any suitable wall as is known in the art.

In one embodiment, the device comprises a body component in the form of a cup, preferably with an inverted dome shape at the closed bottom end. The body component can be manufactured in a dome configuration or a straight cylindrical shape, which is used on shaving cream containers having a relatively straight base wall rather than a pronounced upwardly arcuately shaped and recessed base wall for which the dome shape configuration of the body component is particularly adapted to extend thereinto.

In one embodiment, the body component comprises a thumb tab which is provided on the side walls (i.e., the sleeve), to enable the user to easily remove the device from the shaving cream container. The thumb tab would be the only feature on the otherwise smooth and featureless surface of the side wall.

In one embodiment, the bottom of the body component would comprise bumps or raised areas which provide traction for the device and prevent the shaving cream container from slipping. Specifically, the device would further feature a plurality of high-friction bead structures around the rim of the bottom surface of the body component, which would prevent slippage on wet and/or smooth surfaces.

In one embodiment, the bottom or base of the body component would be manufactured thicker than the top. Specifically, the base would be of a substantial thickness to provide greater weight and more ballast for the shaving cream container, making it more stable and more difficult to inadvertently knock over while shaving or in the shower. Alternate embodiments, wherein the base of the body component would also feature a circular core or plate, manufactured from a material of greater density to provide a greater stabilizing ballast effect, are also contemplated.

In one embodiment, the non-slip shaving cream holder device is preferably manufactured from a flexible, durable material such as rubber, silicone, or plastic. Further, in one embodiment, the device is preferably manufactured in a single piece, preferably by injection molding. Generally, the non-slip shaving cream holder device is also manufactured from a material that is water resistant or waterproof, or the body component comprises a coating that is water resistant or waterproof. Additionally, the device can be made of an antibacterial or antimicrobial material, or the body component comprises a coating that is antibacterial or antimicrobial.

The device is also preferably formed from a stretchable, that is, deformable, rubber or rubber-like material which when relaxed, returns to its normal shape and size. Dependent upon the inherent stretchiness of such material, the device can be made to easily adapt in size and thus fit a wide range of containers, including those that are materially larger in diameter than that of the open top end.

In one embodiment, the exterior surfaces of the non-slip shaving cream holder device can be manufactured in different colors and designs, and/or decorated to match the room in which they are used. Accordingly, the device can be molded in various colors and patterns to match existing decor or may be molded in transparent or translucent plastic as well, such that a user can view the interior of the body component, based upon a user's preference.

In use, the device is positioned on the shaving cream container by placing the closed bottom end of the body component on the lower end of the shaving cream component and stretching the side wall of the body component up and over the body of the shaving cream container progressively, until the device is firmly in place over the shaving cream container, protecting the end of the shaving cream container. Further, the body component is pulled up enough, that any excess material does not interfere with the upright positioning of the shaving cream container. Also, as there is a somewhat tight fit between the body component and the shaving cream container, it is usually necessary and desirable to upwardly push the excess bottom material upward while stretching the side walls outwardly a bit, to remove any air trapped in the body component.

In yet another embodiment, the non-slip shaving cream holder device comprises a plurality of indicia.

In yet another embodiment, a method of retaining and protecting a shaving cream container is disclosed. The method includes the steps of providing a non-slip shaving cream holder comprising a silicone body component in a cylindrical shape. The method also comprises inserting a shaving cream container into the body component, such that the body component wraps around and fully encloses the bottom of a shaving cream container. Further, the method comprises positioning the device on a sink counter for use. Finally, the method comprises mounting the device to a bathroom wall for use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a front perspective view of one embodiment of the non-slip shaving cream holder device of the present invention showing a shaving cream container without the device and with the device applied in accordance with the disclosed architecture;

FIG. 2 illustrates a front perspective view of one embodiment of the non-slip shaving cream holder device of the present invention showing the device with an elongated body component in accordance with the disclosed architecture;

FIG. 3 illustrates a perspective view of one embodiment of the non-slip shaving cream holder device of the present invention showing the device mounted to a wall in accordance with the disclosed architecture;

FIG. 4 illustrates a perspective view of one embodiment of the non-slip shaving cream holder device of the present invention showing the device mounted in a shower in accordance with the disclosed architecture;

FIG. 5 illustrates a front perspective view of one embodiment of the non-slip shaving cream holder device of the present invention showing the device in multiple sizes in accordance with the disclosed architecture; and

FIG. 6 illustrates a flowchart showing the method of retaining and protecting a shaving cream container in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a non-slip shaving cream holder device that provides users with a cylindrical silicone holder designed to accommodate shaving cream containers. There is also a long-felt need in the art for a non-slip shaving cream holder device that allows users to place the holder on a sink surface to keep shaving cream in an easily accessible position. Further, there is a long-felt need in the art for a non-slip shaving cream holder device that prevents rust stains from forming on a sink or other storage area due to the metal shaving cream containers. Moreover, there is a long-felt need in the art for a device that offers a simple and convenient tool for storing shaving cream containers. Further, there is a long-felt need in the art for a non-slip shaving cream holder device that allows users to mount the holder on a wall surface to keep shaving cream in an easily accessible position. Finally, there is a long-felt need in the art for a non-slip shaving cream holder device that is available in multiple sizes to accommodate all types of shaving cream containers.

The present invention, in one exemplary embodiment, is a novel non-slip shaving cream holder device. The device is a holder that keeps a shaving cream can in place to prevent rust on surfaces, such as a sink. The non-slip shaving cream holder device comprises a body component that is configured in a cylindrical shape to be secured to the bottom of a shaving cream container. The body component can also comprise a suction cup component that allows the device to be mounted on a wall surface. Thus, the holder device can be constantly kept in a readily accessible position. The present invention also includes a novel method of retaining and protecting a shaving cream container. The method includes the steps of providing a non-slip shaving cream holder comprising a silicone body component in a cylindrical shape. The method also comprises inserting a shaving cream container into the body component, such that the body component wraps around and fully encloses the bottom of a shaving cream container. Further, the method comprises positioning the device on a sink counter for use. Finally, the method comprises mounting the device to a bathroom wall for use.

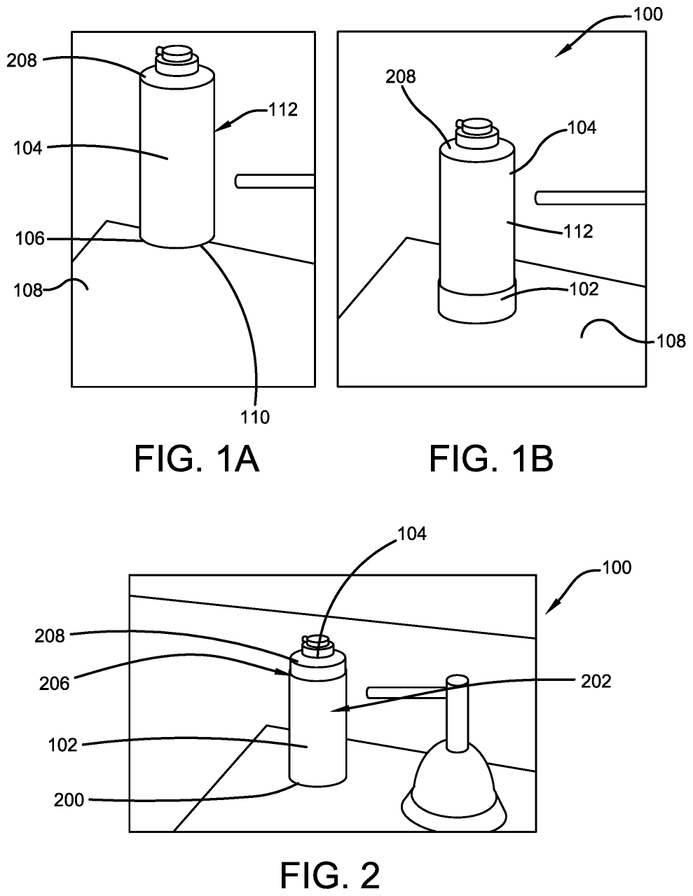

Referring initially to the drawings, FIGS. 1A-B illustrate a perspective view of one embodiment of the non-slip shaving cream holder device 100 of the present invention. In the present embodiment, the non-slip shaving cream holder device 100 is an improved non-slip shaving cream holder device 100 that provides a user with a holder designed to accommodate shaving cream containers 104. Specifically, the non-slip shaving cream holder device 100 comprises a body component 102 that is sized and configured to enclose a bottom 106 of a shaving cream container 104 and keeps a shaving cream container 104 in place and prevents rust on surfaces, such as a sink 108.

Generally, the lower surface of the rim 110 of a conventional shaving cream container 104 forms the surface on which the container 104 is normally supported in an upright position on a bathroom sink 108 or kitchen counter, and it is this surface as well as the lower portions 112 of the container 104 itself that is desired to be protected, since under normal circumstances, it is these areas that are most likely to exhibit rust and leave rust spots or rings brought about either by the direct contact of the rim 110 on the bathroom sink 108 or kitchen counters or by condensation picking up such rust or other contamination, as the condensation rolls down the side of the container 104. Accordingly, the invention is directed to a flexible sleeve (i.e., device 100), which is fitted over the bottom 106 of a conventional shaving cream container 104 to protect it from moisture and from falling into the sink 108 or bathtub 300/shower 400 and becoming damaged.

As shown in FIG. 2, the non-slip shaving cream holder device 100 comprises a body component 102. Typically, the body component 102 is configured in a cylindrical shape but can be any suitable size and shape as is known in the art, depending on the size and shape of the bottom 106 of a shaving cream container 104. Further, the body component 102 would comprise a bottom closed end 200, side walls 202 configured as a sleeve, and a top open end 204 that allows access to an interior cavity 206.

In one embodiment, the side walls 202 (i.e., sleeve) would be a one-quarter inch to a one-half inch tall and once secured to the bottom 106 of the container 104, would cover approximately one-fourth of the container 104. In another embodiment, the side walls 202 would be 1-3 inches tall and once secured to the bottom 106 of the container 104, would cover approximately one-third of the container 104. In yet another embodiment, the side walls 202 would be 3-6 inches tall and once secured to the bottom 106 of the container 104, would cover approximately two-thirds of the container 104. Accordingly, the side walls 202 (i.e., sleeve) can be any suitable length as is known in the art, depending on the needs and/or wants of a user and the size of the shaving cream container 104.

In addition, the height of the side wall 202 is such that the device 100 can be adequately mounted on the lower portion 106 of the shaving cream container 104, yet still have sufficient material remaining to extend across the lower rim 110 of the container 104 and at least extend partially upwards toward the top 208 of the container 104. The height of the side wall 202 can be any suitable size and the device 100 can extend as far up the container 104 as wanted and/or needed by a user.

Furthermore, the open top end 204 of the body component 102 comprises a diameter of at least slightly less and possibly significantly less dependent on its ability to stretch, than that of the diameter of the lower portion 106 (i.e., bottom) of the shaving cream container 104 for which it is adapted to be received thereon.

Generally, the device 100 would be provided in a variety of sizes to fit the containers 104 of all the most popular brands of shaving cream. Further, the device 100 can be provided in a variety of sizes to fit travel-size shaving cream containers or other uniquely sized shaving cream containers. Additionally, the device 100 is available in multiple sizes to accommodate all types of shaving cream containers 104. The non-slip shaving cream holder device 100 is intended to be provided as an attachment by the manufacturer of the shaving cream container 104 or purchased separately as an accessory. Further, the non-slip shaving cream holder device 100 may be used with any suitable cylindrical container that fits into it, such as aerosol cans, etc.

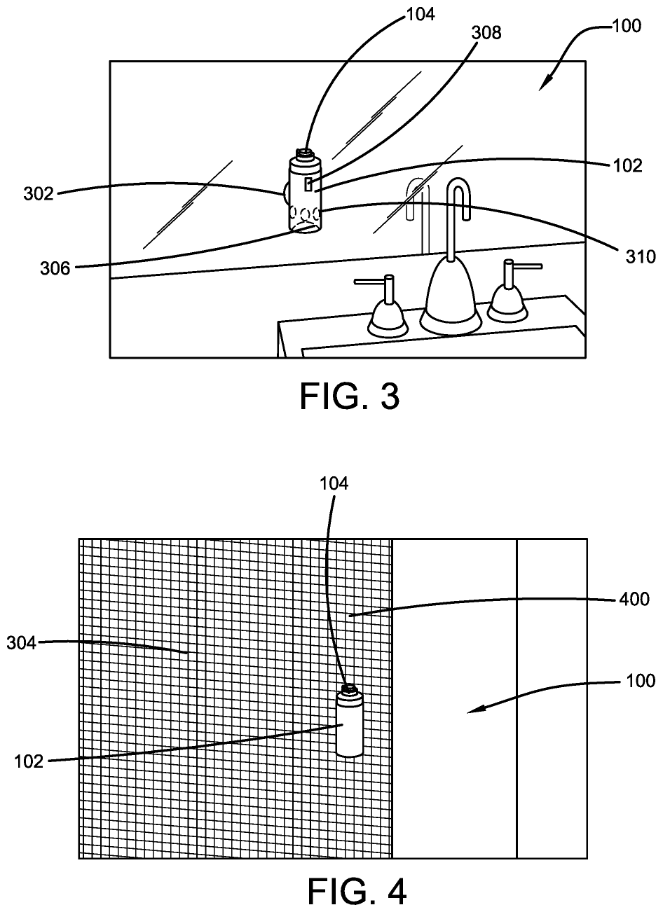

As shown in FIGS. 3-4, the body component 102 comprises a suction cup component 302 that allows the device 100 to be mounted on a wall surface 304. Specifically, the suction cup component 302 is secured to the side wall 202 of the body component 102 in any suitable position. Generally, the suction cup component 302 is glued to the side wall 202 but can be secured via any suitable securing means as is known in the art. Once in place, the suction cup component 302 can be utilized to mount the device 100 to a wall surface 304. Specifically, the device 100 can be mounted via the suction cup component 302, to a shower wall 400, a bathtub wall 300, a bathroom wall, or any suitable wall as is known in the art. It is also contemplated that the suction cup component 302 may not be a suction cup at all and may instead be a Command strip or other adhesive based device.

In one embodiment, the device 100 comprises a body component 102 in the form of a cup, preferably with an inverted dome shape 306 at the closed bottom end 200. The body component 102 can be manufactured in a dome configuration or a straight cylindrical shape, which is used on shaving cream containers 104 having a relatively straight base wall rather than a pronounced upwardly arcuately shaped and recessed base wall, for which the dome shape configuration 306 of the body component 102 is particularly adapted to extend therein.

In another embodiment, the body component 102 comprises a thumb tab 308 which is provided on the side walls 202 (i.e., the sleeve), to enable the user to easily remove the device 100 from the shaving cream container 104. The thumb tab 308 would be the only feature on the otherwise smooth and featureless surface of the side wall 202. Typically, the thumb tab 308 can be any suitable shape and size as is known in the art, such as a circular or square tab, etc.

In yet another embodiment, the bottom 200 of the body component 102 would comprise bumps or raised areas which provide traction for the device 100 and prevent the shaving cream container 104 from slipping. Specifically, the device 100 would further feature a plurality of high-friction bead structures 310 around the rim of the bottom surface 200 of the body component 102, which would prevent slippage of the container 104 on wet and/or smooth surfaces.

In another embodiment, the bottom 200 or base of the body component 102 would be manufactured thicker than the top 204. Specifically, the base 200 would be of a substantial thickness to provide greater weight and more ballast for the shaving cream container 104, making it more stable and more difficult to inadvertently knock over while shaving or in the shower 400. Alternate embodiments, wherein the base 200 of the body component 102 would also feature a circular core or plate, manufactured from a material of greater density to provide a greater stabilizing ballast effect, are also contemplated.

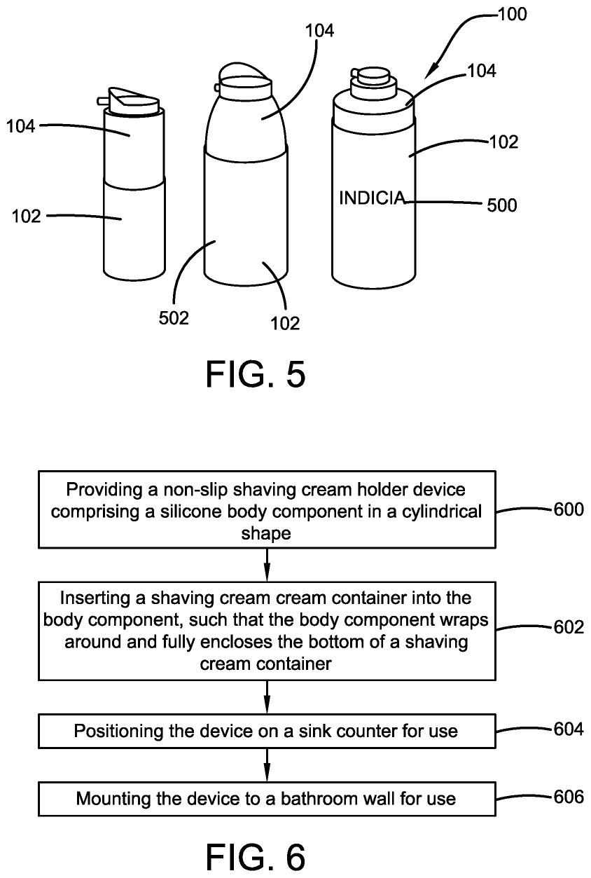

As shown in FIG. 5, the non-slip shaving cream holder device 100 is preferably manufactured from a flexible, durable material such as rubber, silicone, or plastic. Further, in one embodiment, the device 100 is preferably manufactured in a single piece, preferably by injection molding. Generally, the non-slip shaving cream holder device 100 is also manufactured from a material that is water resistant or waterproof, or the body component 102 comprises a coating that is water resistant or waterproof. Additionally, the device 100 can be made of an antibacterial or antimicrobial material or the body component 102 comprises a coating that is antibacterial or antimicrobial.

The device 100 is also preferably formed from a stretchable, that is deformable, rubber or rubber-like material which when relaxed, returns to its normal shape and size. Dependent upon the inherent stretchiness of such material, the device 100 can be made to easily adapt in size and thus fit a wide range of containers 104, including those that are materially larger in diameter than that of the open top end 204.

In one embodiment, the exterior surfaces 502 of the non-slip shaving cream holder device 100 can be manufactured in different colors and designs, and/or decorated to match the room in which they are used. Accordingly, the device 100 can be molded in various colors and patterns to match existing decor or may be molded in transparent or translucent plastic as well, such that a user can view the interior of the body component 102, based upon a user's preference.

In use, the device 100 is positioned on the shaving cream container 104 by placing the closed bottom end 200 of the body component 102 on the lower end 106 of the shaving cream component 104 and stretching the side wall 202 of the body component 102 up and over the body (i.e., the lower portion 112) of the shaving cream container 104 progressively, until the device 100 is firmly in place over the shaving cream container 104, protecting the end 112 of the shaving cream container 104. Further, the body component 102 is pulled up enough, that any excess material does not interfere with the upright positioning of the shaving cream container 104. Also, as there is a somewhat tight fit between the body component 102 and the shaving cream container 104, it is usually necessary and desirable to upwardly push the excess bottom material while stretching the side walls 202 outwardly a bit, to remove any air trapped in the body component 102.

In yet another embodiment, the non-slip shaving cream holder device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be shaving cream, shaving, or brand related.

FIG. 6 illustrates a flowchart of the method of retaining and protecting a shaving cream container. The method includes the steps at 600, providing a non-slip shaving cream holder comprising a silicone body component in a cylindrical shape. The method also comprises at 602, inserting a shaving cream container into the body component, such that the body component wraps around and fully encloses the bottom of a shaving cream container. Further, the method comprises at 604, positioning the device on a sink counter for use. Finally, the method comprises at 606, mounting the device to a bathroom wall for use.

Certain terms are used throughout the following description and claims to refer to particular features or components. As one skilled in the art will appreciate, different users, may refer to the same feature or component by different names. This document does not intend to distinguish between components or features that differ in name but not structure or function. As used herein “non-slip shaving cream holder device”, “shaving cream device”, “holder device”, and “device” are interchangeable and refer to the non-slip shaving cream holder device 100 of the present invention.

Notwithstanding the foregoing, the non-slip shaving cream holder device 100 of the present invention can be of any suitable size and configuration as is known in the art without affecting the overall concept of the invention, provided that it accomplishes the above-stated objectives. One of ordinary skill in the art will appreciate the non-slip shaving cream holder device 100 as shown in FIGS. 1-6 is for illustrative purposes only, and many other sizes and shapes of the non-slip shaving cream holder device 100 are well within the scope of the present disclosure. Although the dimensions of the non-slip shaving cream holder device 100 are important design parameters for user convenience, the non-slip shaving cream holder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-slip shaving cream holder device comprising:
a body component that is cylindrical in shape;
wherein the body component encloses a bottom of a shaving cream container; and
further wherein the body component protects the shaving cream container from rusting and falling into a sink and becoming damaged.

2. The non-slip shaving cream holder device of claim 1, wherein the body component comprises a bottom closed end, side walls configured as a sleeve, and a top open end that allows access to an interior cavity.

3. The non-slip shaving cream holder device of claim 2, wherein the side walls are one-quarter inch tall.

4. The non-slip shaving cream holder device of claim 2, wherein the side walls are one inch tall.

5. The non-slip shaving cream holder device of claim 2, wherein the side walls are three inches tall.

6. The non-slip shaving cream holder device of claim 2, wherein diameter of the top open end is less than diameter of a bottom of the shaving cream container.

7. The non-slip shaving cream holder device of claim 6, wherein the body component comprises a suction cup component that allows the non-slip shaving cream holder device to be mounted on a wall surface.

8. The non-slip shaving cream holder device of claim 7, wherein the bottom closed end of the body component comprises an inverted dome shape that fits into dome configuration of the bottom of the shaving cream container.

9. The non-slip shaving cream holder device of claim 8, wherein the body component comprises a thumb tab which is provided on the side walls to enable a user to easily remove the non-slip shaving cream holder device from the shaving cream container.

10. The non-slip shaving cream holder device of claim 9, wherein a bottom of the body component comprises a plurality of high-friction bead structures to prevent slippage of the shaving cream container on wet surfaces.

11. The non-slip shaving cream holder device of claim 10, wherein the bottom closed end of the body component is manufactured thicker than the top open end to provide greater weight and more ballast for the shaving cream container.

12. The non-slip shaving cream holder device of claim 11, wherein the body component is manufactured of silicone.

13. The non-slip shaving cream holder device of claim 12, wherein exterior surface of the body component comprises colors, patterns and designs to match existing decor.

14. A non-slip shaving cream holder device that provides a user with a holder designed to accommodate shaving cream containers, the non-slip shaving holder device comprising:
a body component made of silicone, that is cylindrical in shape and comprises a bottom closed end, side walls configured as a sleeve, and a top open end that allows access to an interior cavity;
wherein diameter of the top open end is less than diameter of a bottom of the shaving cream container;
wherein the body component comprises a suction cup component that allows the non-slip shaving cream holder device to be mounted on a wall surface;
wherein a bottom of the body component comprises a plurality of high-friction bead structures to prevent slippage of the shaving cream container on wet surfaces;
wherein the bottom closed end of the body component is manufactured thicker than the top open end to provide greater weight and more ballast for the shaving cream container;
wherein the body component encloses a bottom of a shaving cream container; and
further wherein the body component protects the shaving cream container from rusting and falling into a sink and becoming damaged.

15. The non-slip shaving cream holder device of claim 14 further comprising a plurality of indicia.

16. The non-slip shaving cream holder device of claim 14, wherein the side walls are one-quarter inch tall.

17. The non-slip shaving cream holder device of claim 14, wherein the side walls are one inch tall.

18. The non-slip shaving cream holder device of claim 14, wherein the side walls are three inches tall.

19. The non-slip shaving cream holder device of claim 14, wherein the body component comprises a thumb tab which is provided on the side walls to enable a user to easily remove the non-slip shaving cream holder device from the shaving cream container.

20. A method of retaining and protecting a shaving cream container, the method comprising the following steps:
providing a non-slip shaving cream holder device comprising a silicone body component in a cylindrical shape;
inserting a shaving cream container into the body component, such that the body component wraps around and fully encloses the bottom of a shaving cream container; positioning the device on a sink counter for use; and
mounting the device to a bathroom wall for use.
